(19) United States
(12) Patent Application Publication
(10) Pub. No.: US 2015/0044959 A1
(43) Pub. Date: Feb. 12, 2015

(54) VEHICLE AIR-CONDITIONING DEVICE

(71) Applicant: MITSUBISHI HEAVY INDUSTRIES AUTOMOTIVE THERMAL SYSTEMS CO., LTD., Kiyosu-shi, Aichi (JP)

(72) Inventor: Noriyuki Chikagawa, Tokyo (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 14/379,910

(22) PCT Filed: Mar. 4, 2013
(86) PCT No.: PCT/JP2013/055859

§ 371 Date: Aug. 20, 2014

(30) Foreign Application Priority Data
Mar. 9, 2012 (JP) 2012-053025

(51) Int. Cl. B60H 1/34

(52) U.S. Cl. CPC B60H 1/3421; B60H 2001/3478; B60H 2001/3485
USPC 454/152

(57) ABSTRACT

Provided is a vehicle air-conditioning device in which the unit casing is used commonly for an air conditioner designed for manual operation and an air conditioner designed for automatic control so that the variety of the parts and the mold cost can be reduced for a higher production efficiency and a cost reduction. In the vehicle air-conditioning device in which a damper can be turned by manual operation through a lever which is rotatably fitted and supported on a side surface of a unit casing or through an actuator which is directly coupled with a rotational shaft of the damper, a portion of a wall of the unit casing on which the lever is supported is formed as a double wall, and an outer wall of the double wall is provided with a support part on which a fitting part (8) of the lever is rotatably fitted and supported.

### TECHNICAL FIELD

The present invention relates to a vehicle air-conditioning device in which the unit casing can be used commonly for a manually-operated air conditioner and an automatically-operated air conditioner.

### BACKGROUND ART

In a vehicle air-conditioning device, the outside air or the air inside a vehicle (inside air) is taken in and the temperature of the air is regulated through an evaporator, a heater, an air mixing damper, etc., before the air-conditioned air is blown out selectively from one of air outlets, such as a defroster air outlet, a face air outlet, and a foot air outlet, opened to the inside of the vehicle to thereby condition the air inside the vehicle to a set temperature. In the inside of a unit casing of such a vehicle air-conditioning device, various dampers such as an inside/outside air switching damper, an air mixing damper, and multiple air outlet mode dampers are rotatably supported on the unit casing and are installed so as to be turned from the outside.

These dampers are turned individually or in conjunction with one another by manual operation through a lever which is rotatably supported on a side surface of the unit casing, or under automatic control through an actuator which is directly coupled with the rotational shaft of the lever or the rotational shaft of the damper. For example, as shown in PTL 1, the lever is rotatably fitted and supported on the unit casing by an engaging claw, which is provided on a lever (link plate), being fitted and engaged into a through-hole which is provided on a side surface of the unit casing, so that the damper is turned through this lever.

Even among air conditioners (air-conditioning devices) having a lever and designed for manual operation, the position of the lever for a right-hand drive vehicle and that for a left-hand drive vehicle are opposite to each other, so that the separate levers need to be prepared. Thus, in the vehicle air-conditioning device, unavailability of the parts commonly used between the air-conditioning devices designed for manual operation and automatic control and between the air-conditioning devices designed for a right-hand drive vehicle and a left-hand drive vehicle leads to an excessive increase in the variety of the parts and with that an increase in the mold cost. PTL 2 discloses a link device, in which a link lever for driving a door which is rotatably supported on a side surface of a unit casing has a front-back symmetric structure so as to be used commonly for a right-hand drive vehicle and a left-hand drive vehicle.

### CITATION LIST

### Patent Literature

### {PTL 1}

The Publication of Japanese Patent No. 4487436

### {PTL 2}

The Publication of Japanese Patent No. 4552162

### SUMMARY OF INVENTION

### Technical Problem

As mentioned above, in the vehicle air-conditioning device, which differs, even when intended for the same type of vehicle, depending on manual operation and automatic control, and on a right-hand drive vehicle and a left-hand drive vehicle, it is desirable to use the common parts as shown in PTL 2 among these different air-conditioning devices. However, when the configuration as shown in PTL 1 of fitting and engaging the engaging claw into the fitting hole provided in the side surface of the unit casing, instead of the screw fastening structure as shown in PTL 2, is adopted as the structure for supporting the lever on the unit casing, the fitting hole opened in the side surface of the unit casing makes it difficult to use the unit casing commonly for the vehicle air-conditioning device designed for automatic control with the actuator directly coupled with the damper rotational shaft and with the lever omitted. This results in problems such as the increased variety of the unit casing and the increased mold cost.

Having been made in view of this situation, the present invention aims to provide a vehicle air-conditioning device in which the unit casing is used commonly for an air conditioner designed for manual operation and an air conditioner designed for automatic control so that the variety of the parts and the mold cost can be reduced for a higher production efficiency and a cost reduction.

### Solution to Problem

In order to solve the above-described problems, a vehicle air-conditioning device of the present invention has adopted the following solutions:

According to the present invention, there is provided a vehicle air-conditioning device in which a damper can be turned by manual operation through a lever which is rotatably fitted and supported on a side surface of a unit casing, or through an actuator which is directly coupled with a rotational shaft of the damper, wherein a portion of a wall of the unit casing on which the lever is supported is formed as a double wall, and an outer wall of the double wall is provided with a support part on which a fitting part of the lever is rotatably fitted and supported.

According to the present invention, in the vehicle air-conditioning device in which the damper can be turned by manual operation through the lever which is rotatably fitted and supported on the side surface of the unit casing, or through the actuator which is directly coupled with the rotational shaft of the damper, the portion of the wall of the unit casing on which the lever is supported is formed as a double wall, and the outer wall of the double wall is provided with the support part on which the fitting part of the lever is rotatably fitted and supported. In this way, fitting the fitting part of the lever on the support part, which is provided on the outer wall of the double wall, and rotatably fitting and supporting the lever on the unit casing can configure an air conditioner designed for manual operation in which the damper is turned through a lever rotated by a wire, etc. being pulled. On the other hand, even when an air conditioner designed for automatic control, in which the damper is turned through the actuator, is configured with the lever omitted and the actuator directly coupled with the rotational shaft of the damper, no through-hole which penetrates through the side surface of the unit casing is left in the side surface. Thus, according to the present invention, the unit casing can be used commonly for the air conditioner designed for manual operation and the air conditioner designed for automatic control, so that the variety of the parts and the mold cost can be reduced for a higher production efficiency and a cost reduction.

In a vehicle air-conditioning device of a first aspect of the present invention, one of the support part of the outer wall and the fitting part of the lever is provided with a fitting claw part, while the other of the support part and the fitting part is provided with a fitting hole part, into which the fitting claw part is fitted and engaged, and on the outer periphery of the fitting hole part, a bearing boss part, on which a fitting shaft part of the lever is rotatably fitted and supported, is provided in the support part of the outer wall.

According to the first aspect of the present invention, one of the support part of the outer wall and the fitting part of the lever is provided with the fitting claw part, while the other of the support part and the fitting part is provided with the fitting hole part, into which the fitting claw part is fitted and engaged, and on the outer periphery of the fitting hole part, the bearing boss part, on which the fitting shaft part of the lever is rotatably fitted and supported, is provided in the support part of the outer wall. In this way, deforming the fitting claw part and fitting and engaging it into the fitting hole part can retain the lever in the axial direction, and fitting the fitting shaft part into the bearing boss part on the outer periphery of the fitting hole part allows the lever to be rotatably fitted and supported on the support part of the outer wall while preventing deformation and positional shift in the out-of-plane direction of the lever. Thus, according to the first aspect of the present invention, it is possible to support the lever for turning the damper not only easily without using a screw, etc. but also reliably at a predetermined position by preventing deformation and positional shift in the out-of-plane direction of the lever, and thereby to increase the accuracy of the damper stop position.

In a vehicle air-conditioning device of a second aspect of the present invention, the vehicle air-conditioning device is configured such that connecting a wire to a wire connecting pin, which is provided at a predetermined position of the lever, can configure an air conditioner designed for manual operation, while removing the lever to omit it and directly coupling the actuator with the rotational shaft of the damper can configure an air conditioner designed for automatic control.

According to the second aspect of the present invention, the vehicle air-conditioning device is configured such that connecting a wire to the wire connecting pin, which is provided at a predetermined position of the lever, can configure the air conditioner designed for manual operation, while removing the lever to omit it and directly coupling the actuator with the rotational shaft of the damper can configure the air conditioner designed for automatic control. In this way, using the common unit casing and assembling the unit with or without the lever can configure the air conditioner designed for manual operation or the air conditioner designed for automatic control. Thus, according to the second aspect of the present invention, the unit casing can be used commonly for the air conditioner designed for manual operation and the air conditioner designed for automatic control, so that the variety of the parts and the mold cost can be reduced for a higher production efficiency and a cost reduction.

In a vehicle air-conditioning device of a third aspect of the present invention, the lever has a front-back symmetric structure so as to be used commonly for a right-hand drive vehicle and a left-hand drive vehicle.

According to the third aspect of the present invention, the lever has a front-back symmetric structure so as to be used commonly for a right-hand drive vehicle and a left-hand drive vehicle. In this way, mounting the lever with its front side facing the outside for a right-hand drive vehicle and mounting the lever with its back side facing the outside for a left-hand drive vehicle allows one lever to be used commonly for the right-hand drive vehicle and the left-hand drive vehicle. Thus, according to the third aspect of the present invention, in the air conditioner designed for manual operation, the lever for turning the damper can be used commonly for a right-hand drive vehicle and a left-hand drive vehicle, so that the variety of the parts and the mold cost can be reduced for a higher production efficiency and a cost reduction.

In the third aspect of the present invention, a cam groove, which is provided in the lever and into which a pin of a connection lever coupled with the rotational shaft of the damper is engaged, may be a penetrating cam groove without a bottom wall.

According to this configuration, the cam groove, which is provided in the lever and into which the pin of the connection lever coupled with the rotational shaft of the damper is engaged, is the penetrating cam groove without a bottom wall. In this way, one cam groove can be commonly used regardless of whether the lever having a front-back symmetric structure is mounted with its front side or back side facing the outside. Thus, it is possible to facilitate molding of the lever by thinning the portion of the cam groove provided in the lever.

### Advantageous Effects of Invention

According to the present invention, fitting the fitting part of the lever on the fitting support part, which is provided on the outer wall of the double wall part, and rotatably fitting and supporting the lever on the unit casing can configure the air conditioner designed for manual operation in which the damper is turned through the lever rotated by a wire, etc. being pulled. On the other hand, even when the air conditioner designed for automatic control, in which the damper is turned through the actuator, is configured with the lever omitted and the actuator directly coupled with the rotational shaft of the damper, no through-hole which penetrates through the side surface of the unit casing is left in the side surface. Thus, the unit casing can be used commonly for the air conditioner designed for manual operation and the air conditioner designed for automatic control, so that the variety of the parts and the mold cost can be reduced for a higher production efficiency and a cost reduction.

### BRIEF DESCRIPTION OF DRAWINGS

FIG. 1A is a perspective outside view of a vehicle air-conditioning device when designed for a right-hand drive vehicle according to one embodiment of the present invention.

FIG. 1B is a perspective outside view of the vehicle air-conditioning device when designed for a right-hand drive vehicle according to one embodiment of the present invention, with its lever removed.

FIG. 2A is a perspective outside view of a vehicle air-conditioning device when designed for a left-hand drive vehicle according to one embodiment of the present invention.

FIG. 2B is a perspective outside view of the vehicle air-conditioning device when designed for a left-hand drive vehicle according to one embodiment of the present invention, with its lever removed.

FIG. 3A is a perspective view from the left side of the lever of the vehicle air-conditioning device according to one embodiment of the present invention.

FIG. 3B is a perspective view from the right side of the lever of the vehicle air-conditioning device according to one embodiment of the present invention.

FIG. 4A is a cross-sectional view of a unit casing of the vehicle air-conditioning device according to one embodiment of the present invention, with the lever of a lever support part mounted.

FIG. 4B is a cross-sectional view of the unit casing of the vehicle air-conditioning device according to one embodiment of the present invention, with the lever of the lever support part removed.

FIG. 5A is a configuration diagram of a drive system showing a damper of the vehicle air-conditioning device according to one embodiment of the present invention being manually operated through the lever.

FIG. 5B is a configuration diagram of the drive system showing the damper of the vehicle air-conditioning device according to one embodiment of the present invention being automatically controlled through the lever.

### DESCRIPTION OF EMBODIMENTS

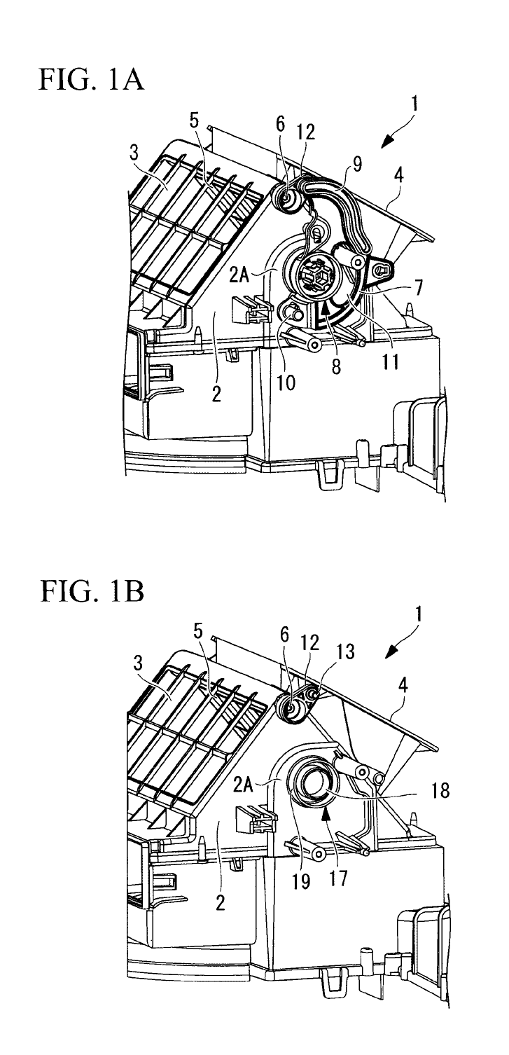

In the following, one embodiment of the present invention will be described with reference to FIG. 1 through FIG. 5.

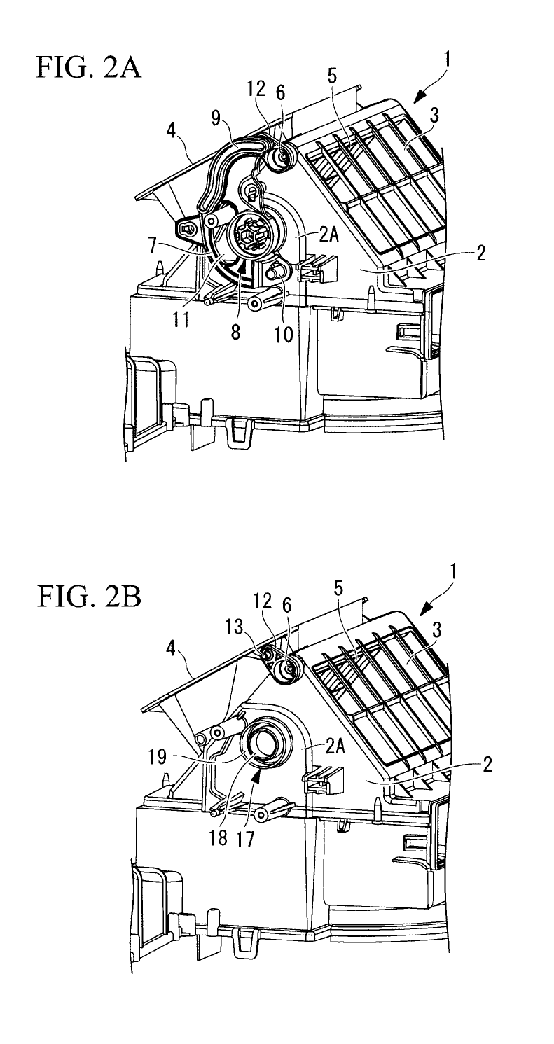

FIG. 1A is a perspective outside view of a vehicle air-conditioning device when designed for a right-hand drive vehicle according to one embodiment of the present invention. FIG. 1B is a perspective outside view of the vehicle air-conditioning device when designed for a right-hand drive vehicle according to one embodiment of the present invention. FIG. 2A is a perspective outside view of a vehicle air-conditioning device designed for a left-hand drive vehicle. FIG. 2B is a perspective outside view of the vehicle air-conditioning device designed for a left-hand drive vehicle with the lever removed.

The vehicle air-conditioning device (air conditioner) has a configuration in which an air intake unit 1 and a blower unit are provided in a portion on the upstream side of an HVAC unit (Heating Ventilation and Air Conditioning Unit) where an evaporator, a heater, an air mixing damper, etc. are disposed.

When the above-described HVAC unit is positioned at the center of the vehicle, the air intake unit 1 is typically positioned on the front passenger seat side, which is the left side of the HVAC unit, in a right-hand drive vehicle, and positioned on the front passenger seat side, which is the right side of the HVAC unit, in a left-hand drive vehicle. The air intake unit 1 has a unit casing 2. On the upper surface side of the unit casing 2, an inside air introduction port 3 opened to the inside of the vehicle and an outside air introduction port 4 opened to the outside air side are provided at a tilt. The outside air introduction port 4 is connected through a duct with an outside air intake port located outside the vehicle.

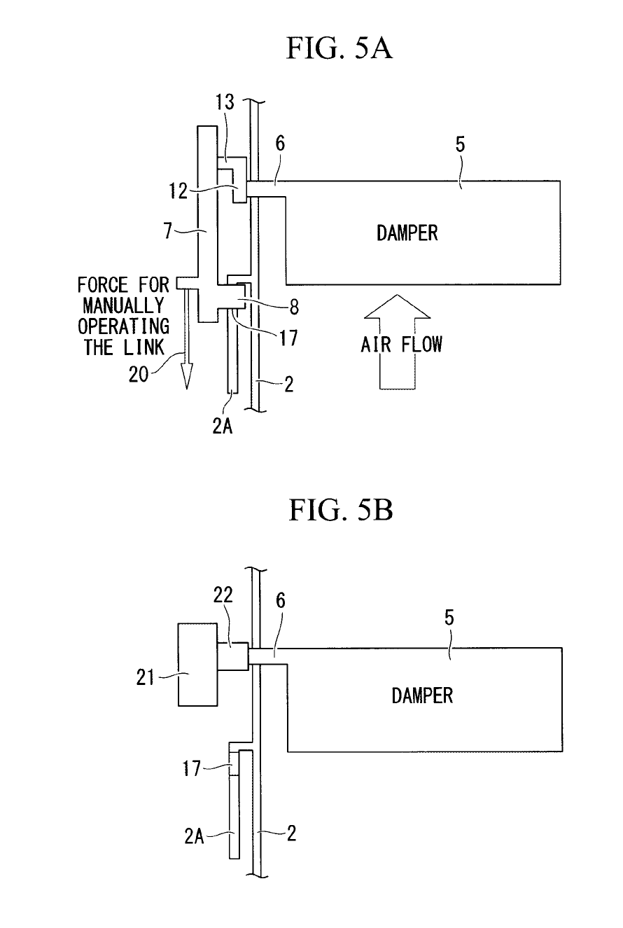

In the inside of the unit casing 2, an inside/outside air switching damper (damper) 5 (see FIG. 5A and FIG. 5B), which can switch such that one of the inside air introduction port 3 and the outside air introduction port 4 is closed while the other is opened, is turnably supported through a rotational shaft 6. However, this does not rule out the possibility that the inside/outside air switching damper 5 is adjusted by being turned to an intermediate position between the inside air introduction port 3 and the outside air introduction port 4 so that both the inside air (the air inside the vehicle) and the outside air can be taken in at the same time. The blower unit (not shown) is coupled with the unit casing 2 on the lower side, so that the inside air or the outside air taken in from the inside air introduction port 3 or the outside air introduction port 4 of the air intake unit 1 can be delivered to the HVAC unit on the downstream side.

A lever 7, which is rotated by a wire 20 (see FIG. 5A), to be described later, being pulled and which turns the inside/outside air switching damper 5 when the inside/outside air switching damper 5 is switched by being turned through manual operation, is rotatably fitted and supported on the side surface of the unit casing 2 on the HVAC unit side. As shown in FIG. 1A and FIG. 2A, this lever 7 is mounted so as to face one side in the air conditioner designed for a right-hand drive vehicle and face the other side in the air conditioner designed for a left-hand drive vehicle.

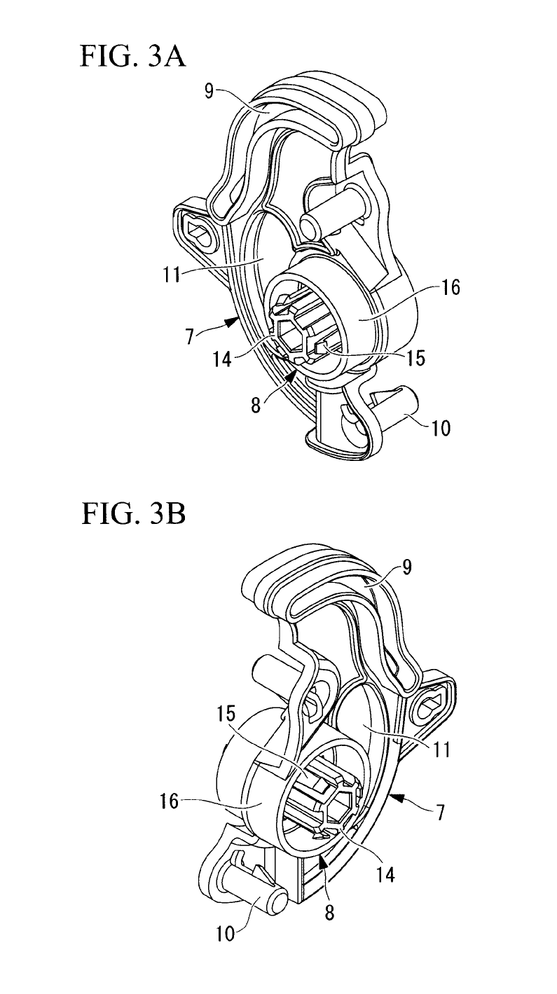

FIG. 3A and FIG. 3B are perspective views from the left and right sides of the lever 7.

The lever 7 is provided with a fitting boss part (fitting part) 8 at the center part, and is a plate-like integral molded part of a resin material (e.g., PBT, POM, etc.) provided with multiple reinforcing ribs in the radial direction and the circumferential direction, and on the outer periphery of the lever 7, a cam groove 9 for turning the inside/outside air switching damper 5 is provided. The lever 7 is also provided with a wire connecting pin 10, to which the wire 20 for manual operation is connected, in a portion on the side opposite to the portion where the cam groove 9 is provided across the fitting boss part 8, and the lever 7 is further provided with an arc-shaped cutout 11 along the outer peripheral portion of the fitting boss part 8.

As shown in FIGS. 3A and 3B, the above-described lever 7 has a front-back symmetric structure so as to be used commonly for a right-hand drive vehicle and a left-hand drive vehicle, and the cam groove 9, into which the pin 13 of a connection lever 12 coupled with the rotational shaft 6 of the inside/outside air switching damper 5 is slidably engaged, is a penetrating cam groove 9 without a bottom wall. This lever 7 is rotatably fitted, engaged, and supported, through the fitting boss part 8, on a fitting hole part 18 and a bearing boss part 19 to be described later of a fitting support part (support part) 17 provided on the side surface of the unit casing 2.

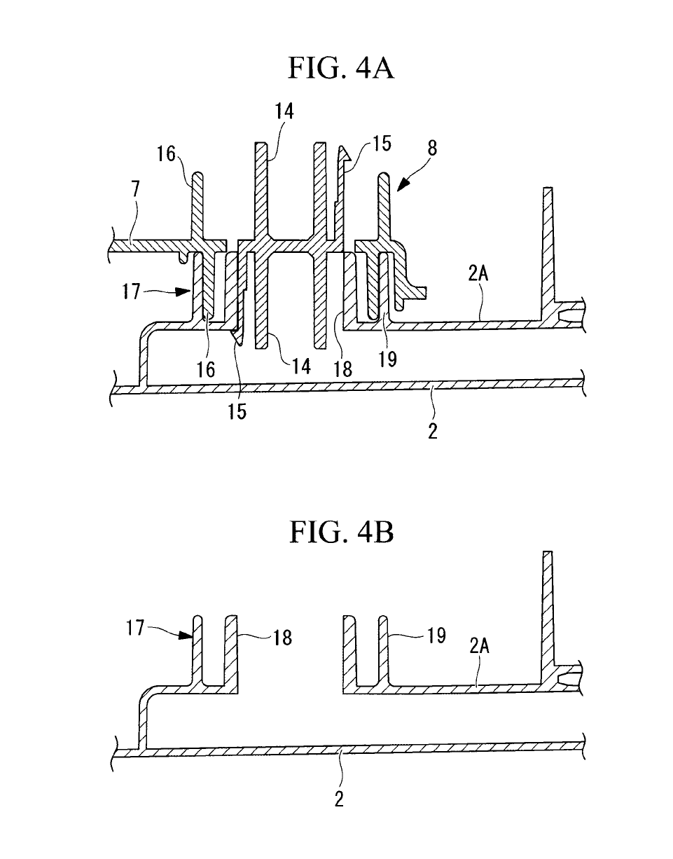

That is, as shown in FIG. 4A, multiple elastically deformable fitting claw parts 15, which are provided at regular intervals at three or more positions in the circumference around a shaft part 14 and which are fitted and engaged into the fitting hole part 18 of the fitting support part 17, and a cylindrical fitting shaft part 16 which is integrally provided on the outer periphery of the fitting claw parts 15 so as to protrude outward and which is rotatably fitted on the bearing boss part 19 of the fitting support part 17, are integrally molded on the front side and the back side, respectively, of the fitting boss part (fitting part) 8 of the lever 7.

On the other hand, the unit casing 2 is molded of a resin material such as PP, and on the side surface of the unit casing 2 on the HVAC unit side, the fitting support part (support part) 17, on which the lever 7 is rotatably fitted and supported, is integrally molded so as to protrude outward. As shown in FIG. 4A and FIG. 4B, the portion of the side surface of the unit casing 2 where the fitting support part 17 is provided has partially a double-wall structure, and the fitting support part 17 is provided on an outer wall 2A of the double wall.

As shown in FIG. 4A and FIG. 4B, the fitting hole part 18, which penetrates the outer wall 2A on which the shaft part 14 and the fitting claw parts 15 provided on the fitting boss part 8 of the lever 7 are fitted and engaged, and the cylindrical bearing boss part 19, which is provided on the outer periphery of the fitting hole part 18 and on whose inner peripheral surface the fitting shaft part 16 provided in the fitting boss part 8 of the lever 7 is rotatably fitted, are integrally molded on the outer wall 2A of the fitting support part (support part) 17.

As shown in FIG. 5A, when the air conditioner designed for manual operation is to be configured, fitting and engaging the fitting boss part 8 of the lever 7 on the fitting support part 17 of the unit casing 2 can rotatably install the lever 7. Further, engaging the pin 13 of the connection lever 12 coupled with the rotational shaft 6 of the inside/outside air switching damper (damper) 5 into the cam groove 9 of the lever 7 and connecting the wire 20 for manual operation to the wire connecting pin 10 can configure the inside/outside air switching damper 5 so as to be turned through the lever 7 rotated by the wire 20 being pulled and to be manually switchable.

When the air conditioner designed for automatic control is to be configured, removing the lever 7 as shown in FIG. 1B and FIG. 2B and directly coupling an output shaft 22 of an actuator 21 with the rotational shaft 6 of the inside/outside air switching damper 5 as shown in FIG. 5B allows the inside/outside air switching damper 5 to be turned through the actuator 21 and to be switched under automatic control. The actuator 21 can be fixedly installed in the boss part, etc. provided on the side surface of the unit casing 2.

In this case, where the lever 7 is omitted, since the lever 7 is fitted and supported on the fitting support part 17 provided on the outer wall 2A of the double wall of the unit casing 2, even when the lever 7 is removed, no through-hole communicates the inside and the outside of the unit casing 2, so that the unit casing 2 can be used commonly for the air conditioner designed for manual operation and the air conditioner designed for automatic control.

While in the above-described embodiment the fitting claw parts 15 are provided in the fitting boss part 8 of the lever 7 and the fitting hole part 18 is provided in the fitting support part 17 provided on the outer wall 2A of the unit casing 2, as opposed to this configuration, the fitting hole part may be provided in the fitting boss part 8 and the fitting claw parts may be provided on the outer wall 2A of the unit casing 2.

Thus, according to this embodiment, in the vehicle air-conditioning device in which the inside/outside air switching damper (damper) 5 can be turned by manual operation through the lever 7 which is rotatably fitted and supported on the side surface of the unit casing 2, or through the actuator 21 which is directly coupled with the rotational shaft 6 of the inside/outside air switching damper 5, the portion of the wall of the unit casing 2 on which the lever 7 is supported is formed as a double wall, and the outer wall 2A of the double wall is provided with the fitting support part (support part) 17 on which the fitting boss part (fitting part) 8 of the lever 7 is rotatably fitted and supported.

In this way, fitting the fitting boss part 8 of the lever 7 on the fitting support part 17, which is provided on the outer wall 2A of the double wall, and rotatably fitting and supporting the lever 7 on the unit casing 2 can configure the air conditioner designed for manual operation in which the inside/outside air switching damper 5 is turned through the lever 7 rotated by the wire 20 being pulled. On the other hand, even when the air conditioner designed for automatic control, in which the inside/outside air switching damper 5 is turned through the actuator 21, is configured with the lever 7 omitted and the actuator 21 directly coupled with the rotational shaft 6 of the inside/outside air switching damper 5, no through-hole which penetrates through the side surface of the unit casing 2 is left in the side surface.

Thus, the unit casing 2 can be used commonly for the air conditioner designed for manual operation and the air conditioner designed for automatic control, so that the variety of the unit casing 2 and the mold cost can be reduced for a higher production efficiency and a cost reduction.

In this embodiment, one of the fitting support part 17 of the outer wall 2A of the unit casing 2 and the fitting boss part 8 of the lever 7 is provided with the fitting claw parts 15, while the other of the fitting support part 17 and the fitting boss part 8 is provided with the fitting hole part 18, into which the fitting claw parts 15 are fitted and engaged, and on the outer periphery of the fitting hole part 18, the bearing boss part 19, on which the fitting shaft part 16 of the lever 7 is rotatably fitted and supported, is provided in the fitting support part 17 of the outer wall 2A.

In this way, deforming the fitting claw parts 15 and fitting and engaging them into the fitting hole part 18 can retain the lever 7 in the axial direction, and rotatably fitting the fitting shaft part 16 into the bearing boss part 19 on the outer periphery of the fitting hole part 18 allows the lever 7 to be rotatably fitted and supported on the fitting support part 17 on the outer wall 2A while preventing deformation and positional shift in the out-of-plane direction of the lever 7. Thus, it is possible to support the lever 7 for turning the inside/outside air switching damper 5 not only easily without using a screw, etc. but also reliably at a predetermined position by preventing deformation and positional shift in the out-of-plane direction of the lever 7, and thereby to increase the accuracy of the stop position of the inside/outside air switching damper 5.

The vehicle air-conditioning device is configured such that connecting the wire 20 to the wire connecting pin 10, which is provided at a predetermined position of the lever 7, can configure the air conditioner designed for manual operation, while removing the lever 7 to omit it and directly coupling the actuator 21 with the rotational shaft 6 of the inside/outside air switching damper 5 can configure the air conditioner designed for automatic control. In this way, using the common unit casing 2 and assembling the unit with or without the lever can configure the air conditioner designed for manual operation or the air conditioner designed for automatic control. Thus, the unit casing 2 can be used commonly for the air conditioner designed for manual operation and the air conditioner designed for automatic control, so that the variety of the parts and the mold cost can be reduced for a higher production efficiency and a cost reduction.

In this embodiment, the lever 7 has a front-back symmetric structure so as to be used commonly for a right-hand drive vehicle and a left-hand drive vehicle. In this way, mounting the lever 7 with its front side facing the outside in a right-hand drive vehicle, and mounting the lever 7 with its back side facing the outside in a left-hand drive vehicle allows one lever 7 to be used commonly for the right-hand drive vehicle and the left-hand drive vehicle. Thus, in the air conditioner designed for manual operation, the lever 7 for turning the inside/outside air switching damper 5 can be used commonly for a right-hand drive vehicle and a left-hand drive vehicle, so that the variety of the parts and the mold cost can be reduced for a higher production efficiency and a cost reduction.

The cam groove 9, which is provided in the lever 7 and into which the pin 13 of the connection lever 12 coupled with the rotational shaft 6 of the inside/outside air switching damper 5 is engaged, is the penetrating cam groove 9 without a bottom wall. In this way, one cam groove 9 can be commonly used regardless of whether the lever 7 having a front-back symmetric structure is mounted with its front side or back side facing the outside. Thus, it is possible to facilitate molding of the lever 7 by thinning the portion of the cam groove 9 provided in the lever 7.

The present invention is not limited to the invention according to the above-described embodiment, but modifications can be made appropriately without departing from the scope of the present invention. For example, while in the above-described embodiment the present invention is applied to the fitting support part 17 of the lever 7 for turning the inside/outside air switching damper 5 of the air intake unit 1, needless to say, the present invention may as well be applied to a support part of similar levers for turning other dampers on the HVAC unit side.

### REFERENCE SIGNS LIST

1 Air intake unit
2 Unit casing
2A Outer wall
5 Inside/outside air switching damper (damper)
6 Rotational shaft
7 Lever
8 Fitting boss part (fitting part)
9 Cam groove
10 Wire connecting pin
15 Fitting claw part
16 Fitting shaft part
17 Fitting support part (support part)
18 Fitting hole part
19 Bearing boss part
20 Wire
21 Actuator

1. A vehicle air-conditioning device in which a damper can be turned by manual operation through a lever which is rotatably fitted and supported on a side surface of a unit casing, or through an actuator which is directly coupled with a rotational shaft of the damper, wherein
a portion of a wall of the unit casing on which the lever is supported is formed as a double wall, and an outer wall of the double wall is provided with a support part on which a fitting part of the lever is rotatably fitted and supported.

2. The vehicle air-conditioning device according to claim 1, wherein one of the support part of the outer wall and the fitting part of the lever is provided with a fitting claw part, while the other of the support part and the fitting part is provided with a fitting hole part, into which the fitting claw part is fitted and engaged, and on the outer periphery of the fitting hole part, a bearing boss part, on which a fitting shaft part of the lever is rotatably fitted and supported, is provided in the support part of the outer wall.

3. The vehicle air-conditioning device according to claim 1, wherein
the vehicle air-conditioning device is configured such that connecting a wire to a wire connecting pin, which is provided at a predetermined position of the lever, can configure an air conditioner designed for manual operation, while removing the lever to omit it and directly coupling the actuator with the rotational shaft of the damper can configure an air conditioner designed for automatic control.

4. The vehicle air-conditioning device according to claim 1, wherein
the lever has a front-back symmetric structure so as to be used commonly for a right-hand drive vehicle and a left-hand drive vehicle.

5. The vehicle air-conditioning device according to claim 4, wherein
a cam groove, which is provided in the lever and into which a pin of a connection lever coupled with the rotational shaft of the damper is engaged, is a penetrating cam groove without a bottom wall.
